(19) United States
(12) Patent Application Publication
(10) Pub. No.: US 2008/0118175 A1
(43) Pub. Date: May 22, 2008

(54) Creating A Variable Motion Blur Effect

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/560,721

(22) Filed: Nov. 16, 2006

(51) Int. Cl. G06K 9/40

(52) U.S. Cl. 382/264

(57) ABSTRACT

An original image is comprised of pixels that are arranged in a first order. In one embodiment, an apparatus creates a blur effect in a portion of the original image. The portion is divided into at least two bands. The apparatus includes a buffer, a pixel modification unit, and a selection unit. The buffer stores a plurality of original image pixels. The pixel modification unit determines a replacement pixel for a corresponding original image pixel of a particular segment by calculating an average of the corresponding original image pixel and at least one other original image pixel of the particular segment. A segment is a plurality of sequential pixels in one of the at least two bands. The selection unit selects the corresponding original image pixel and the at least one other pixel. The number of other pixels selected varies with the band in which the segment is located. In one embodiment, the at least one other pixel follows the corresponding original image pixel in the first order. The first order may be a raster order. In another embodiment, the buffer is a shift register.

### FIELD OF INVENTION

The field of invention relates to methods and apparatus for creating a variable motion blur effect in digital photography.

### BACKGROUND

If the subject of a photograph moves during an exposure, the subject will appear blurred in the resulting photograph. The blurred subject appears to be in motion. In addition, the subject of a photograph that is stationary during an exposure may have a blur effect applied to it to create the impression that the subject is in motion. A blur effect may be applied to the subject of a photograph using special-purpose software for manipulating digital photographs. Such photograph editing software typically runs on a personal computer, requiring substantial amounts of processing and memory to store program code and multiple copies of the digital image containing the subject to be blurred.

Digital cameras are rapidly replacing traditional film cameras. In addition, digital cameras are often being incorporated into mobile devices, such as mobile telephones. Many users of digital cameras are casual photographers. The casual photographer may desire to apply a blur effect to a subject, but not if it requires purchasing and learning to use photograph editing software. Photograph editing software is not inexpensive and it takes time to learn how to use such software. Photograph editing software may cost more than the digital camera or mobile device and requires the purchase of a computer. Photograph editing software may take many hours to learn and requires a familiarity with computers. In addition, creating a blur effect using photograph editing software involves a time delay. For example, a blur effect can not be applied to a photograph taken on holiday until days later when the user returns home and transfers the photograph to a computer.

Accordingly, a function for creating a variable motion blur effect for use in digital cameras and camera-equipped mobile devices that minimizes processing and storage requirements, and which could be used to apply a blur effect contemporaneously with or soon after image capture, would be desirable.

### SUMMARY

An original image is comprised of pixels that are arranged in a first order. Certain embodiments are directed to an apparatus for creating a blur effect in a portion of the original image. The portion is divided into at least two bands. The apparatus includes a buffer, a pixel modification unit, and a selection unit. The buffer stores a plurality of original image pixels. The pixel modification unit determines a replacement pixel for a corresponding original image pixel of a particular segment by calculating an average of the corresponding original image pixel and at least one other original image pixel of the particular segment. A segment is a plurality of sequential pixels in one of the at least two bands. The selection unit selects the corresponding original image pixel and the at least one other pixel. The number of other pixels selected varies with the band in which the segment is located. In one embodiment, the at least one other pixel follows the corresponding original image pixel in the first order. The first order may be a raster order. In another embodiment, the at least two bands divide the original image horizontally and the number of other pixels selected for inclusion in the average increases with the band moving from left to right in the original image. In one alternative, the number of other pixels selected for inclusion in the average decreases with the band moving from left to right in the original image. In yet another embodiment, the at least two bands divide the original image vertically, and the first order proceeds in columns from the top row to the bottom row of the original image. In a further embodiment, the buffer is a shift register.

Other embodiments are directed a method for creating a blur effect in a portion of an original image. The original image is comprised of pixels arranged in a first order. The method includes: (a) dividing the portion of the original image into at least two bands; (b) creating a first modified pixel to replace a corresponding first original image pixel; and (c) creating a second modified pixel to replace a corresponding second original image pixel. The first modified pixel is created by computing the average of the first original image pixel and one other original image pixel, wherein the first and the one other original image pixels are included in a first segment of the original image. The first segment is a plurality of sequential pixels in a first band. The second modified pixel is created by computing the average of the second original image pixel and at least two other original image pixels, wherein the second original image pixel and the at least two other original image pixels are included in a second segment of the original image the second segment is a plurality of sequential pixels in a second band. In one embodiment, the one other original image pixel immediately follows the first original image pixel in the first order. In addition, the at least two other original image pixels immediately follow the second original image pixel in the first order. In an alternative embodiment, the first and second segments are respective portions of the same row of the original image. The first order may be a raster order. In an additional embodiment, the first and second segments are respective portions of the same column of the original image. The first order may proceed in columns from the top row to the bottom row of the original image.

Other embodiments are directed to a medium readable by a machine embodying a program of instructions for execution by the machine to perform a method for creating a blur effect in a portion of an original image comprised of pixels arranged in a first order. In one embodiment, the method includes the steps of: (a) dividing the portion of the original image into at least two bands; (b) causing a first plurality of pixels of a first segment of the original image to be stored in a buffer; and (c) replacing a first original image pixel of the first segment with an average of the first original image pixel and one other original image pixel of the first segment. The first segment may be all of a plurality of a consecutive sequence of pixels mutually extending in the same direction in a first band. In addition, the method may include the steps of (d) causing a second plurality of pixels of a second segment of the original image to be stored in the buffer; and (e) replacing a second original image pixel of the second segment with an average of the second original image pixel and at least two other original image pixels of the second segment. The second segment may be all of a plurality of a consecutive sequence of pixels mutually extending in the same direction in a second band. In one alternative, the one other original image pixel immediately follows the first original image pixel in the first order, and the at least two other original image pixels immediately follow the second original image pixel in the first order. In another alternative, the first order is a raster order.

### BRIEF DESCRIPTION OF THE DRAWINGS

FIG. 1 depicts a prophetical digital image that includes a region selected for a motion blur effect.

FIG. 2 shows an enlarged view of the selected region of FIG. 1 in which the selected region includes a sub-region.

FIG. 3 shows an enlarged view of the sub-region of FIG. 2, which illustrates bands of pixels and selected portions of rows (segments) of pixels within the bands.

FIG. 4 shows an enlarged view the portions of rows (segments) of pixels of FIG. 3 before and after each has been modified to obtain the appearance of motion blur according to one embodiment of the claimed inventions.

FIG. 5 illustrates the notation used in this document to designate original image pixels and modified pixels.

FIG. 6 shows an exemplary method for filling a band buffer that is used to store one row of pixels of one band according to one embodiment of the claimed inventions.

FIG. 7 shows an exemplary method for creating modified pixels from the original image pixels stored in a band buffer according to one embodiment of the claimed inventions.

FIG. 8 illustrates a block diagram of a graphics display system having a variable motion blur unit according to one embodiment of the claimed inventions.

FIG. 9 illustrates a block diagram of the variable motion blur unit of FIG. 8.

FIG. 10 shows a block diagram of one example of a circuit for creating modified pixels according to one embodiment of the claimed inventions.

In the drawings and description below, the same reference numbers are used in the drawings and the description to refer to the same or like parts, elements, or steps.

### DETAILED DESCRIPTION

In this document, particular structures, processes, and operations well known to the person of ordinary skill in the art may not be described in detail in order to not obscure the description. As such, embodiments of the claimed inventions may be practiced even though such details are not described. On the other hand, certain structures, processes, and operations may be described in some detail even though such details may be well known to the person of ordinary skill in the art. This may be done, for example, for the benefit of the reader who may not be a person of ordinary skill in the art. Accordingly, embodiments of the claimed inventions may be practiced without some or all of the specific details that are described.

In this document, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Methods and apparatus of the claimed inventions can be used in “mobile devices.” A mobile device is a computer or communication system, such as a mobile telephone, personal digital assistant, digital music player, digital camera, or other similar device. Accordingly, as an example, one preferred embodiment of the claimed inventions is described below in the context of a mobile device. It should be appreciated, however, that embodiments of the claimed inventions may be employed in any device capable of processing image data, including but not limited to computer and communication systems and devices generally.

A digital image comprises a two-dimensional array of picture elements or pixels. In a raster scan pattern, a digital image is scanned pixel-by-pixel in rows from the left side of the image to the right side, and from the top row to the bottom row of the image. Image data is often transmitted, stored, and rendered on a display device in raster order.

Data values define how each pixel will appear when it is displayed. An 8, 16, 24, or 32 bit data word may be used, for example, to define each pixel in an image. An 8-bit data word can be used to represent one of 256 different shades of gray. A 24-bit data word may be used to define pixels in an RGB color model, where three 8-bit words represent the red, green, and blue components of each pixel's color. Because pixels are represented by numbers, various arithmetic operations may be performed on pixels. In various embodiments described herein, two or more pixels are “averaged.” The averaging operations according to embodiments of the claimed inventions may be practiced with images having pixels of any number of bits. For example, two or more 8-bit gray-scale pixels may be averaged. In addition, the averaging operation may include individually averaging the components pixels having multiple components, such as RGB or YUV pixels. For instance, the average value of a color pixel may be calculated by separately averaging the red components, the green components, and the blue components of two or more 24-bit RGB pixels.

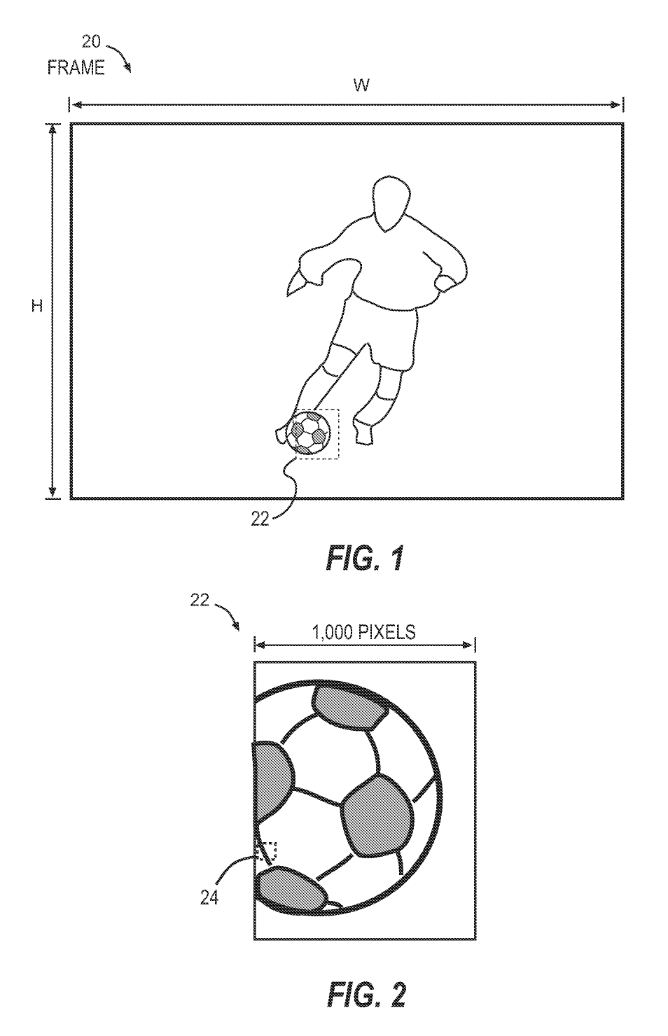

FIGS. 1 to 5 illustrate one example of how an image of an object having an appearance of motion blur may be created from a single image of the object according to one embodiment of the claimed inventions.

FIG. 1 shows an exemplary digital image 20 having a height (H) and width (W). A dashed line indicates a rectangular region 22 of the original image 20 that is selected for a blur effect.

FIG. 2 shows an enlarged view of the region 22, which has a width of 1,000 pixels. A portion of the region 22 is designated as a sub-region 24. While not shown in FIG. 2, the region 22 is divided into fifty equal-sized vertical bands 26.

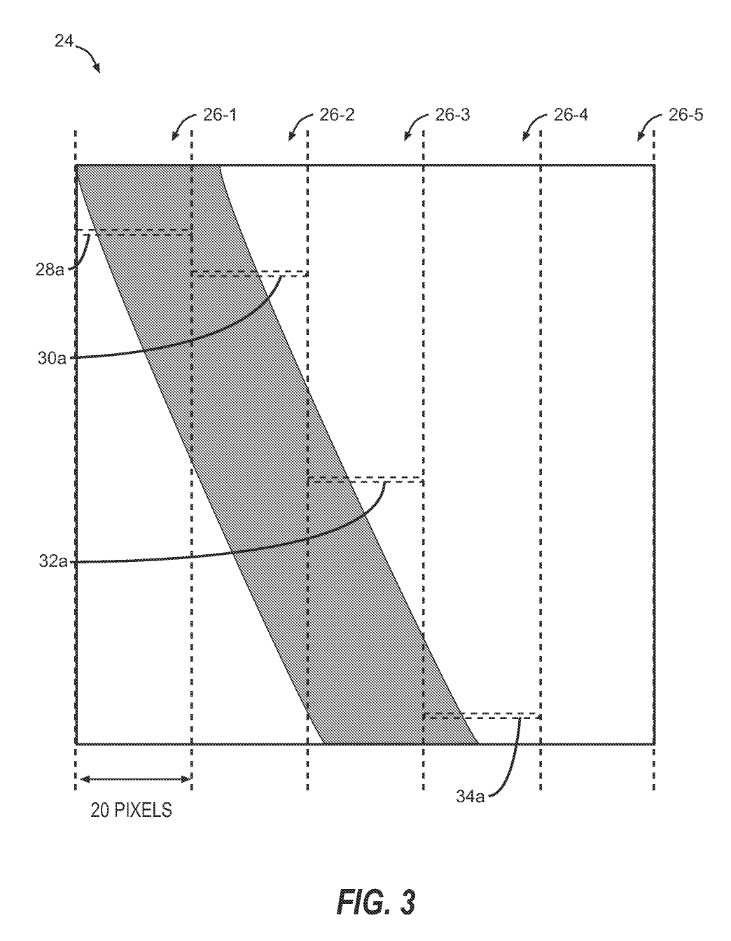

FIG. 3 shows an enlarged view of the sub-region 24 in which several of the vertical bands 26 may be seen. In this example, each of the bands 26 has a width of twenty pixels. FIG. 3 also shows selected portions of rows of pixels 28a, 30a, 32a, and 34a of the bands 26-1, 26-2, 26-3, and 26-4, respectively. (28a, 30a, etc. are portions of rows as a full row of pixels extends the entire width W of the image.)

A portion of a row of pixels, such as the portion 28a, is also referred to herein as a “segment.” As explained below, the bands 26 may be also horizontal. For this reason, the term “segment” is also used herein to refer to a portion of a column of pixels. In addition, as mentioned above, image data are often arranged in raster order. If pixels are not arranged in raster, it is assumed herein that the image data are arranged in a particular order. Taking the ordering of pixels into consideration, it can be said that the pixels in a segment are consecutive pixels in the sequence or order in which the pixels are arranged. Further, as can be seen from FIG. 3, the pixels in a segment are horizontally adjacent to one another on a particular line. In addition, in the case in which a segment is a portion of a column of pixels, it may be said that the pixels of a segment are vertically adjacent to one another in a particular column. More generally then, a “segment” refers to a group of pixels, all of which are within a particular band, that are consecutive pixels in the sequence in which the pixels are arranged, and that mutually extend in the same direction (horizontally or vertically) within the band. There will generally be a plurality of segments for each band.

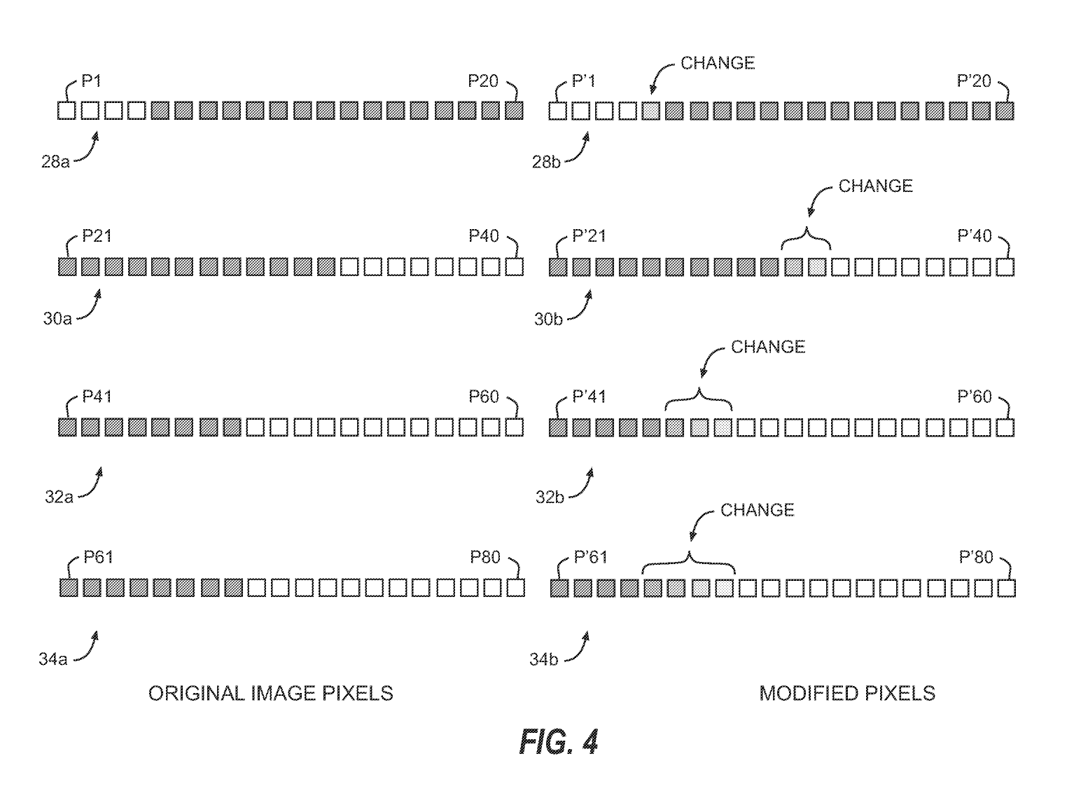

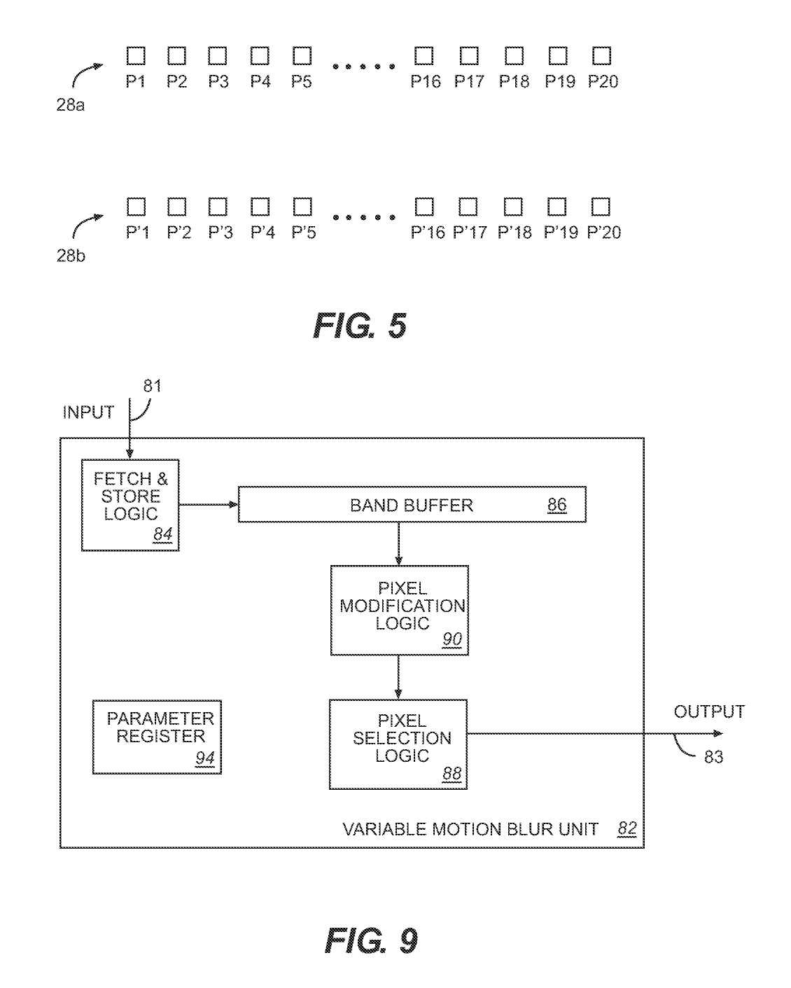

FIG. 4 shows an enlarged view of segments 28a, 30a, 32a, and 34a, in which individual “original image pixels” may be seen. In addition, FIG. 4 shows each segment after it has been modified to obtain the appearance of motion blur according to one embodiment. The segments 28a, 30a, 32a, and 34a become, after modification, respectively, segments of “modified pixels” 28b, 30b, 32b, and 34b. The particular pixels in the segments 28b, 30b, 32b, and 34b that change as a result of the modification are indicated in FIG. 4. In this example, one, two, three, and four of the modified pixels of the row portions 28b, 30b, 32b, and 34b, respectively, change in value from original image pixels in corresponding positions of rows portions 28a, 30a, 32a, and 34a.

FIG. 5 illustrates the notation used in this document to designate original image pixels and modified pixels. Original image pixels, e.g., those in segment 28a, are designated by a “P” and numbered sequentially from left to right, e.g., P1, P2, P3, etc. Corresponding modified pixels, e.g., those in segment 28b, are designated and numbered similarly, but with a prime added to note that a particular pixel is a modified pixel.

To explain how the modification is performed, let the original image pixels in row portion 28a be numbered P0-P20, and let the modified pixels in row portion 28b be numbered P′0-P′20. Similarly, let the original image pixels in row portions 30a, 32a, and 34a be numbered P21-P40, P41-P60, and P61-P80, respectively. In addition, let the modified pixels in the row portions 30b, 32b, and 34b be numbered P′21-P′40, P′41-P′60, and P′61-P′80, respectively.

The equations below provide one example of how particular pixels may be modified to create an appearance of motion blur according to the claimed inventions. In the first band 26-1, a modified pixel is formed by averaging it with a neighbor pixel to the left in the same segment. In the second band 26-2, a modified pixel is formed by averaging the original with its two left neighbor pixels in the same segment. Similarly, in the third and fourth bands, 26-3 and 26-4, a modified pixel is formed by averaging the original with its three and four neighboring pixels to the left in the same segment, respectively.

$$\begin{matrix}{P}^{′} 1 = \frac{P 1 + P 2}{2} \\ {P}^{′} 20 = \frac{P 20 + P 21}{2} & Band 26 \text{-} 1 \\ {P}^{′} 21 = \frac{P 21 + P 22 + P 23}{2} \\ {P}^{′} 40 = \frac{P 40 + P 41 + P 42}{3} & Band 26 \text{-} 2 \\ {P}^{′} 41 = \frac{P 41 + P 42 + P 43 + P 44}{4} \\ {P}^{′} 60 = \frac{P 60 + P 61 + P 62 + P 63}{4} & Band 26 \text{-} 3 \\ {P}^{′} 61 = \frac{P 61 + P 62 + P 63 + P 64 + P 65}{5} \\ {P}^{′} 80 = \frac{P 80 + P 81 + P 82 + P 83 + P 84}{5} & Band 26 \text{-} 4\end{matrix}$$

### In addition, as mentioned above, the region 22 is 1,000 pixels wide and comprised of fifty vertical bands 26. Accordingly, two equations for the right-most band in the region are shown below.

$${P}^{′} 981 = \frac{P 981 + P 982 + P 983 + … + P 998 + P 999 + P 1000}{20} \\ {P}^{′} 1000 = \frac{P 1000 + P 1001 + P 1002 + … + P 1018 + P 1019 + P 1020}{20} \qquad Band 26 \text{-} 50$$

As the examples above illustrate, after an image of an object is divided into equal sized vertical bands, the pixels within each band are averaged to produce a second image of the object having an appearance of motion blur. For each original image pixel, a modified pixel is produced. In the examples, each modified pixel is created from an average that includes the corresponding original image pixel and one or more original image pixels to the left of the particular original image pixel in the same segment. The number of pixels in the average used to produce a modified pixel is the same for each pixel within a band. In the example, the number of pixels in the average used to produce a modified pixel increases with each band moving from left to right. That is, the number of pixels included in the average increases with movement to the right, i.e., from band 26-1 to band 26-50. As the number of pixels included in the average increases, the degree of blurring increases. Thus, band 26-1 has the least amount of blurring and band 26-50 the most. This produces a visual effect such that the object appears to move in a leftward direction. The right portion of the object is in focus, and moving to the left object increasingly loses focus as individual pixels are blended with increasing numbers of pixels to the left. In another embodiment, the number of pixels included in the average decreases with movement to the right. More generally, the number of pixels included in the average may vary from band-to-band as desired.

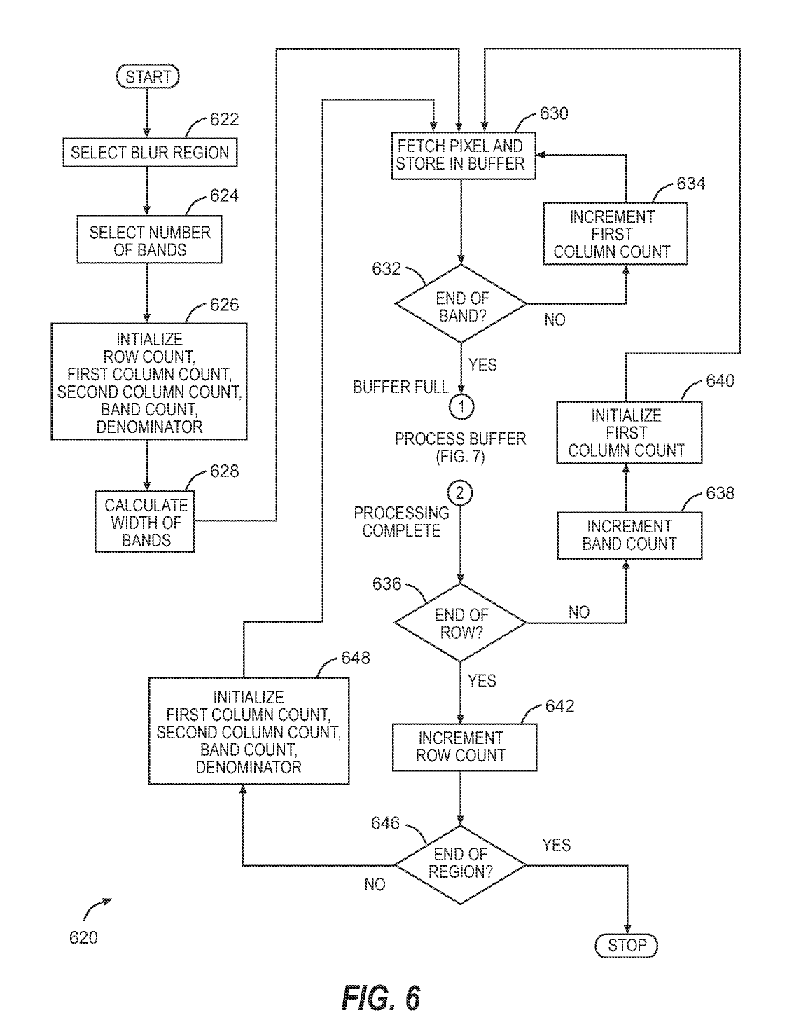

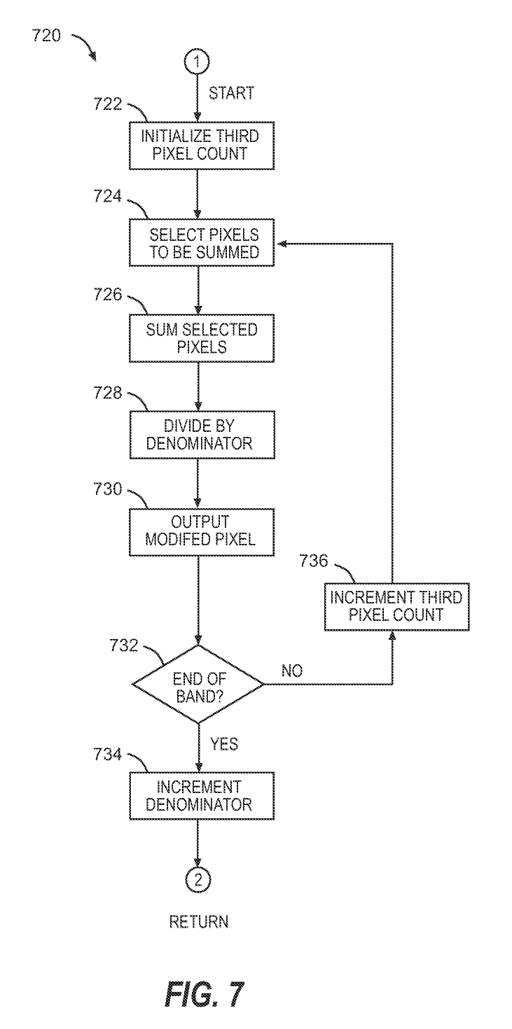

FIGS. 6 and 7 show flow diagrams that illustrate exemplary methods according to one embodiment of the claimed inventions. FIG. 6 shows a method 620 in which blur region is specified and various process parameters are initialized. In addition, the method 620 includes steps for repeatedly filling a buffer (a “band buffer”) used to store one row portion or segment of pixels for one band. FIG. 7 shows a method 720. The method 720 is a sub-process of the method 620 in which modified pixels are created from original image pixels stored in the band buffer. After the method 620 finishes processing pixels stored in the band buffer, control returns to method 720. The method 720 repeatedly fills the band buffer and the method 620 repeatedly creates modified pixels from original image pixels until all pixels within the specified blur region have been processed.

As shown in FIG. 6, the method may begin with specifying a blur region (step 622) and selecting a number of bands (step 624). While the blur region is typically only a portion of the full image, the blur region may be specified as the entire original image. In step 626, variables for keeping track of various counts and tallies used in the methods 620, 720 are initialized. In addition, a denominator used in a division operation is initialized for use in creating modified pixels from a first band of original image pixels. The size of the bands, specified in terms of pixels, may be calculated, for example, by dividing the width (or height) of the blur region by the number of bands (step 628). For horizontal bands, the size of the bands is a width. For vertical bands, the size of the bands is a height. Typically, the bands are of equal size, but in alternative embodiments, the bands may be of varying sizes.

The two variables selected in steps 620 and 622 determine the rate or degree of blurring. In the example above, the width of the region 22 is 1,000 pixels and the number of bands is 50. Accordingly, it is determined that the region 22 is to be blurred in fifty horizontal steps of 20 pixels (step 628). A slower rate of blur may be achieved by selecting a smaller number of bands for a given width. For example, selecting 25 as the number of bands, the resulting blur effect is implemented in 25 horizontal steps, each band being 40 pixels wide. A faster rate of blur may be achieved by selecting a larger number of bands. For example, selecting 100 as the number of bands, the resulting blur effect is implemented in horizontal 100 steps, each band being 10 pixels wide. In an alternative embodiment, a rate of blurring is directly specified in lieu of specifying a particular number of bands. From the specified rate of blurring and the specified width of the blur region, the number of bands may be determined.

Row and band counts or tallies are initialized (step 626). In addition, first and second column counts or tallies are initialized. Further, a denominator used in a division operation is initialized for use in creating modified pixels from a first band of original image pixels. The width of the bands is calculated from the specified number of bands as described above (step 628). An original image pixel from the selected blur region is fetched (step 630).

Original image pixels may be fetched or received in raster order. In one embodiment, the digital image 20 or the region 22 may be stored in a memory in raster sequence and the original image pixels are fetched from the memory in the same raster sequence. In another embodiment, the pixels of the digital image 20 or the region 22 are received in raster sequence from a transmitting device, such as an image sensor. In this embodiment, an original image pixel is received from the transmitting device instead of being fetched from a memory in the step 630. Regardless of whether the pixel is fetched or received, the pixel is stored in a band buffer in step 630.

In alternative embodiments, the original image pixels are either fetched or received in a sequence other than a raster sequence. In one alternative, a scan pattern that moves in rows from the right side of an image to the left side may be employed. In one alternative, a scan pattern that moves from the bottom row to the top row of an image may be employed. In yet other alternatives, a scan pattern that scans an image in columns either from top-to-bottom or bottom-to-top may be used. After a column is scanned, the pattern proceeds to the next adjacent column, moving either right-to-left or left-to-right.

After a pixel has been fetched and stored in the band buffer, a test of the first column count is made (step 632). The first column count is compared with the width of the band. For example, the pixels in the first row of the region 22 would be compared with a width of 20 pixels specified for the bands. As the loop comprised of steps 630-632-634 shows, the first 20 pixels of the first row would be fetched and stored in the band buffer. When the pixel in 21 St column is fetched, however, the comparison (step 632) would indicate that the end of the band had been reached. At this point the method proceeds to step 722 (FIG. 7). The method 720 for creating modified pixels from the pixels stored in the band buffer, as described below, uses the pixel data for the first band of pixels 26-1 stored in the buffer and when the method 720 is complete control is returned the method 620 at step 636.

After control is returned by the method 720, a second test of a second column count is made (step 636). This second test compares the second column count with the width of the region 22. In the above example, the region is 1,000 pixels wide. If the second column count is less than 1,000 pixels, the end of a row has not been reached. In this case, the band count is incremented (step 638), the first column count is initialized (step 640), and the loop comprised of steps 630-632-634 is entered where another band is fetched and stored in the band buffer. In the above example, these steps would be repeated for each of the bands of pixels 26-1 to 26-50.

After the band 26-50 has been fetched and stored in the band buffer, and processed according to the method 720, the second test of the second column count is made (step 636). This time the second test (step 636) indicates that the end of the row is reached. The row count is incremented (step 642). A test is made of the row count to determine if the last row in the blur region has been processed (step 646). If the test is negative, various variables are re-initialized (step 648), as shown in FIG. 6, and the above described steps are repeated for the next row of the blur region. On the other hand, should the result of the test of step 646 be positive, the method terminates.

Turning now to FIG. 7, the shown method 720 for creating modified pixels from original image pixels assumes that the band buffer is filled with original image pixels. As described above, each time the band buffer is filled with a new band of original image pixels, control transfers to the method 720.

A third pixel count or tally is initialized (step 722). The third pixel count here refers to the number of pixels in the band, e.g., 20.

In step 724, the original image pixels to be summed are selected. Because the original image pixels are stored in particular locations in the band buffer, the step 724 may require selecting particular storage locations in the band buffer. Determining which original image pixels to be summed or the locations where such pixels are stored depends on two things. First, it depends on the band being processed. Second, it depends on which modified pixel is being created.

Determining the particular original image pixels to be summed depends on the band being processed. In general, a varying number of pixels will be selected in step 724. On the assumption that raster order processing is used, as the band being processed moves from left-to-right, the number of pixels selected in step 724 increases with each band processed. Referring again to the example presented above, for band 26-1 two pixels may be selected. For band 26-2 three pixels may be selected, for band 26-3 four pixels may be selected, and so on. In more general terms, for any given band K, k pixels may be selected.

Determining the original image pixels to be summed also depends on the particular modified pixel to be created. The third pixel tally identifies the particular modified pixel to be created. Each modified pixel corresponds to an original image pixel, as shown in FIG. 5, e.g., P′1 corresponds to P1. Assuming that raster order processing is used, the original image pixels to be summed includes: (a) original image pixel that corresponds to the modified pixel to be created; and (b) one or more neighboring original pixels to the left of the corresponding original image pixel. How many pixels neighboring pixels are selected depends on the band. In general, for any given band K, k minus 1 neighbor pixels to-the-left will be selected. Continuing the example, for band 26-1 two pixels may be selected. In this band, (a) pixels P20 and P19 are selected to create modified pixel P′20; (b) pixels P19 and P18 are selected to create modified pixel P′19; and (c) pixels P18 and P17 are selected to create modified pixel P′18. As another example, for band 26-2 three pixels may be selected. In band 26-2, (a) pixels P20, P19, and P18 are selected to create modified pixel P′20; (b) pixels P19, P18, and P17 are selected to create modified pixel P′19; and (c) pixels P18, P17, and P16 are selected to create modified pixel P′18.

After the original image pixels to be summed are selected, they are summed (step 726) and the result is divided by the denominator applicable for the particular band (step 728). The result is a modified pixel that is output in step 730. At step 732, a determination is made whether all of the modified pixels for the particular band have been created. This may be accomplished by comparing the value of the third pixel count with the width of the band. If more modified pixels for the particular band need to be created, the third pixel count is incremented (step 736) and steps 724 to 732 are repeated. If all modified pixels for the particular band have been created, the denominator is incremented and control returns to the step 636 of method 620.

As mentioned above, determining which original image pixels are to be summed depends on the particular modified pixel to be created. An example was given in which, for any given band K, an original image pixel and k minus 1 neighbor pixels to-the-left original image pixel are selected to be summed. In one alternative, neighbor pixels to-the-right of the original image pixel may be selected. In another alternative, neighbor pixels are selected from both the right and left of the original image pixel. Moreover, if the segments are portions of columns, the selected neighbor pixels are above or below the original image pixel.

The method 620 described above includes steps for completely filling a band buffer used to store a segment of pixels. It should be appreciated that it is not critical that the band buffer be completely filled before modified pixels are created. The band buffer may be filled with less than one full segment of original image pixels. In an alternative embodiment, the band buffer is filled with enough original image pixels sufficient to create a modified pixel.

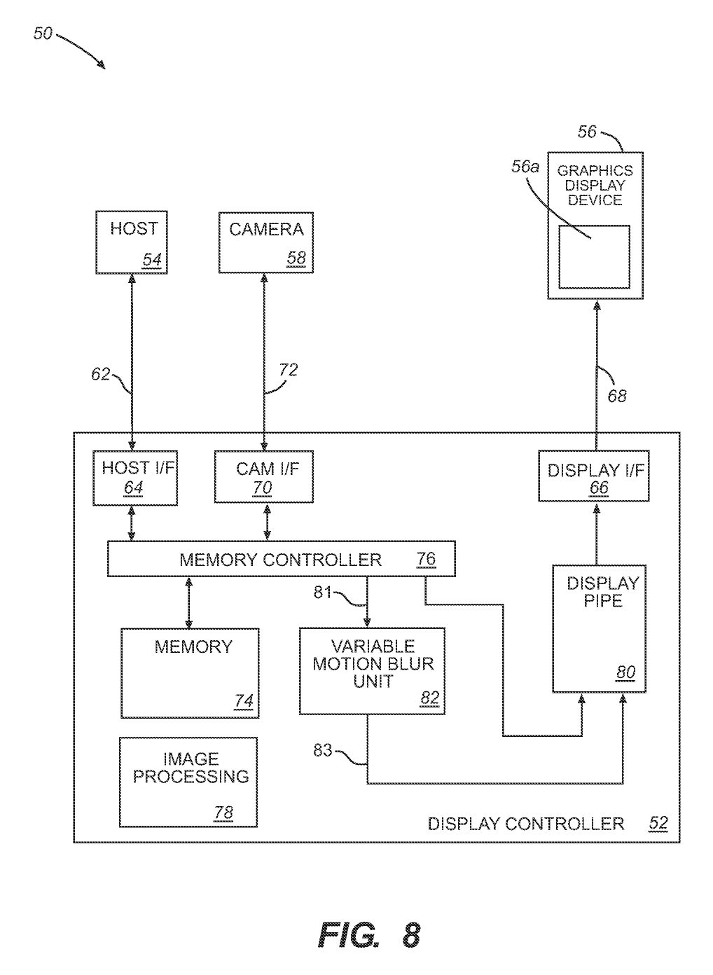

FIG. 8 shows a graphics display system 50 for processing image data to create an object having an appearance of motion blur from a single image of the object according to one embodiment of the claimed inventions.

The graphics display system 50 includes a display controller 52. The system 50 may be a mobile device. Where the system 50 is a mobile device, it is typically powered by a battery (not shown). The system 50 may include a host 54, a graphics display device 56, and one or more image data sources, such as a camera module or image sensor (“camera”) 58.

The display controller 52 interfaces the host and image data sources with the display device 56. In one embodiment, the display controller 52 is a separate integrated circuit from the remaining elements of a system, that is, the display controller is “remote” from the host, camera, and display device. In alternative embodiments, one or more functions of the display controller 52 may be performed by other units in a system.

The host 54 is typically a microprocessor, but may be a digital signal processor, a computer, or any other type of controlling device adapted for controlling digital circuits. The host 54 communicates with the display controller 52 over a bus 62 to a host interface 64 in the display controller.

A display device interface 66 is included in the display controller 52. The display device 56 has a display area 56a where pixel data is displayed. The display device interface 66 provides an interface between the display controller 52 and the display device 56. A display device bus 68 couples the display controller 52 and the display device 56. LCDs are typically used as display devices in portable digital appliances, such as mobile telephones, but any device(s) capable of rendering pixel data in visually perceivable form may be employed. The term “display device” is used in this specification to broadly refer to any of a wide variety of devices for rendering images. The term display device is intended to also include hardcopy devices, such as printers and plotters. The term display device additionally refers to all types of display devices, such as CRT, LED, OLED, and plasma devices, without regard to the particular display technology employed.

A camera interface 70 (“CAM I/F”) is included in the display controller 52. The camera interface 70 receives pixel data output on data lines of a bus 72. Typically, the camera 58 also receives vertical and horizontal synchronizing signals from the camera and provides to the camera a camera clocking signal for clocking the pixel data out of the camera. These signals may be transmitted via the bus 72.

A memory 74 is included in the display controller 52. The memory 74 may be used for storing frames of image data and other types of data. In other embodiments, however, the memory 74 may be remote from the display controller. The memory 74 is of the SRAM type, but the memory 74 may be a DRAM, Flash memory, hard disk, optical disk, floppy disk, or any other type of memory. Data are stored in and fetched from the memory 74 under control of a memory controller 76. The memory controller 76 is coupled with the memory 74, the host interface 64, and the camera interface 70 thereby permitting the host and the camera to access the memory.

An image processing block, indicated generally as 78, may be included in the display controller 52. The image processing block performs one or more image processing operations on image data provided by an image data source. The image processing block 78 may include, for example, a CODEC for compressing and decompressing image data, a resizer for scaling and cropping the data, and a color converter for converting the color format of the data. Image processing operations, such as cropping, scaling, compression encoding, and color converting, may be performed as the data are received, “on the fly,” or they may be performed on data that have been stored in a memory.

Typically, the image data stored in the memory 74 are fetched and transmitted through a display pipe 80 to the display interface 66. The display pipe 80 is coupled with the memory controller 76 in order to access the memory 74. In one embodiment, the display pipe 80 is a FIFO buffer. From the display interface 66, image data is passed via the display device bus 68 to the display device 56.

A variable motion blur unit 82 according to the claimed inventions may also be included in display controller 52. The variable motion blur unit 82 is coupled with the memory controller 76 via a bus 81 and the display pipe 80 via a bus 83.

FIG. 9 illustrates a block diagram of one example of a variable motion blur 82 unit. The blur unit 82 includes fetch and store block 84, a band buffer 86, a pixel selection block 88, a block 90 for creating modified pixels, and a parameter register 94. The parameter register 94 stores various process parameters. For example, parameters for defining the blur region, the number and width of the bands, the rate or degree of blurring, as well as the various counts and tallies described above may be stored in the parameter register 94 for the nonexclusive use of other elements of the variable motion blur unit 82.

The band buffer 86 may store one segment of original image pixels. In general, modified pixels are created from original image pixels of the same band. In addition, certain modified pixels are created from original image pixels of the same band and of an adjacent band. Therefore, the band buffer 86 may also store these additional pixels. For instance, in the example above the band 26-1 includes original image pixels P1 to P20. The modified image pixel P′20 is created from the original image pixels P20 and P21. The original image pixel P21 is not part of the band 26-1. Nevertheless, the original image pixel P21 may be stored in the band buffer so that the modified pixel P′20 may be created.

Alternatively, the band buffer 86 may store less that one segment of original image pixels. In general, fewer than all of the pixels in a segment are used to compute an average. In the example above, just two original image pixels are needed to compute a replacement pixel in Band 26-1. Yet Band 26-1 is a 20 pixel segment. Accordingly, the band buffer 86 may store just 2 pixels or 10 percent of the original image pixels of a segment. While the band buffer 86 may store less that one segment of original image pixels, it must store at least the number of pixels required to compute a modified pixel that corresponds to an original pixel of a particular band.

The band buffer 86 may include logic for selecting original image pixels to be used in creating a particular modified image pixel. For example, with respect to band 26-1, the band buffer 86 selects the original image pixels P1 and P2 for use in creating modified pixel P′1. As another example, the band buffer 86 selects the original image pixels P20 and P21 for use in creating modified pixel P′20. In one embodiment, the band buffer 86 is a shift register and original image pixel selection is performed by a shift operation. The shift operation may be initiated when a new pixel is stored in the band buffer 86 or in response to a clock signal. Alternatively, the shift operation may be initiated by a signal provided by a unit separate from the band buffer 86 that is specially designed to select pixels.

In an alternative embodiment, the logic for selecting original image pixels is provided separately from the band buffer 86 in the pixel selection block 88. In this embodiment, the band buffer 86 need not be a shift register. If, however, the band buffer 86 is a shift register, the pixel selection block 88 may provide a shift signal to band buffer. The pixel selection block 88 may include logic or execute code to select original image pixels as a function of the particular modified pixel being created and the particular band. Such logic may, for example, include a plurality of multiplexers designed to couple particular storage locations with particular summing units in a block 90.

The block 90 is employed to create modified pixels. The block 90 adds selected pixels and divides the sum by a denominator appropriate for the band. For instance, to create the modified pixel P′1, the block 90 sums the selected original image pixels P1 and P2. The sum is then divided by two to produce modified pixel P′1. The block 90 may output modified pixels on a bus 83.

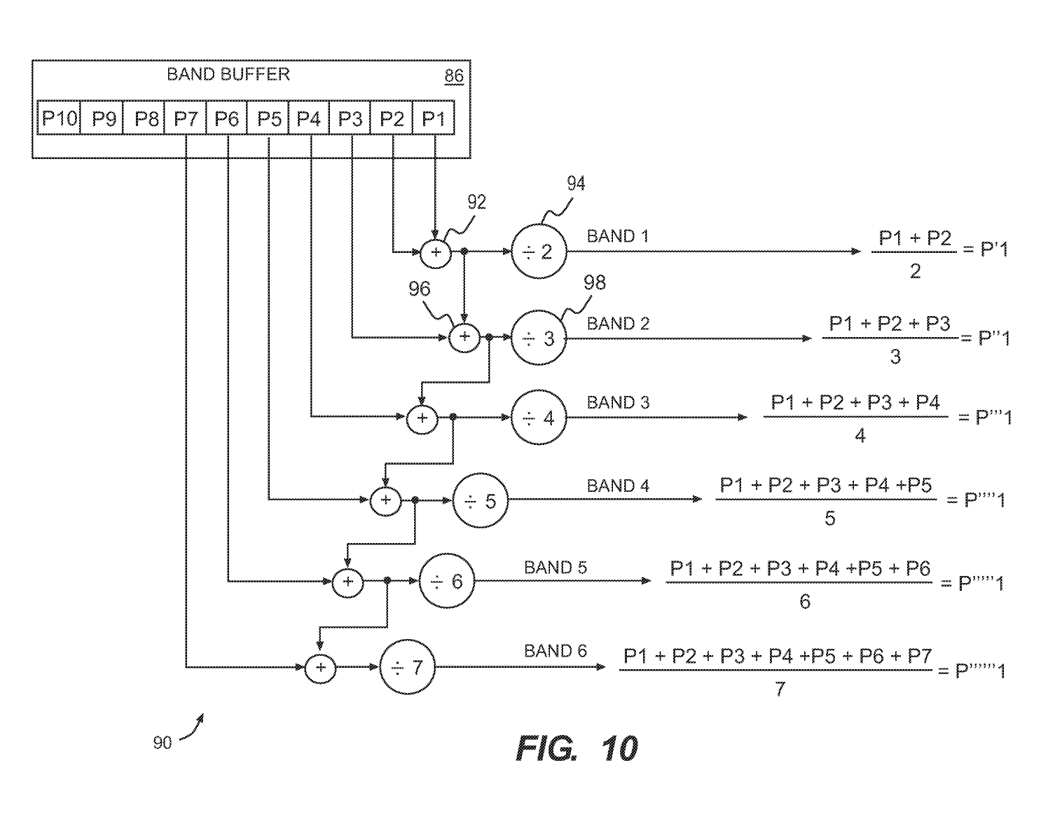

Alternatively, the block 90 may be configured as shown in FIG. 10. In the embodiment of FIG. 10, the pixel modification block 90 is configured to simultaneously output two or more modified pixels. When the block 90 is configured in this manner, the pixel modification block 90 is coupled with the band buffer 86 and the pixel selection block 88 as shown in FIG. 9, and the pixel selection block 88 selects one modified pixel from the two or more modified pixels simultaneously output by the modification block 90. The pixel selection block 88 places the selected pixel on the bus 83

FIG. 10 illustrates the band buffer 86 and one embodiment of the block 90 for creating modified pixels. In FIG. 10, a first modified pixel for each of the bands 1 to 6 is shown. The modified pixel for band 26-1 is designated with a single prime, i.e., P′1. As the band number increases, an additional prime is added. For example, band 26-2 is designated P″1, band 26-3 is designated P′″1, and so on. The band buffer 86 shown in FIG. 10 may be a shift register. Two examples illustrate the operation of the circuit shown in FIG. 10.

### EXAMPLE ONE

To create pixel P′1 for band 26-1, the values of pixels P1 and P2 are summed by adder 92 and divided by two by divider 94. To create pixel P′2 for band 26-1, the pixels in the band buffer 86 are shifted one position to the right, and then the values of pixels P2 and P3 are summed by adder 92 and divided by two by divider 94.

### EXAMPLE TWO

To create pixel P″1 for band 26-2, the values of pixels P1, P2, and P3 are summed by adders 92 and 96. This sum is divided by three by divider 98. To create pixel P″2 for band 26-2, the pixels in the band buffer 86 are shifted one position to the right, and then the values of pixels P2, P3, and P4 are summed by adders 92 and 96. This sum is divided by three by divider 98.

Original image pixels may be fetched or received in raster order. In addition, in alternative embodiments, original image pixels may be fetched or received in a sequence other than a raster sequence. When raster order is employed, the resulting motion blur effect is horizontal, with blur increasing from left to right. The direction of the motion blur may be changed by fetching or receiving pixels in an order other than raster order. For example, if a reverse raster scan pattern is employed, i.e., moving in rows from the right side of an image to the left side, a horizontal blur increasing from right to left is created. In addition, the direction of the motion blur may be changed by dividing the blur region into vertical bands and fetching or receiving pixels in an order that moves in columns, either from the top row to the bottom row of an image, or from the bottom row to the top row. When pixels are fetched or received in columns, a vertical blur effect is produced.

The direction of the motion blur may also be changed by changing how the average used to compute a modified pixel changes with each band. In the raster order example above, the number of pixels included in an average increases with each band moving from left to right in the image. As such the horizontal blur increases from left to right. If the number of pixels included in an average decreases with each band moving from left to right in the image, the horizontal blur decreases from left to right.

One advantage of embodiments of the claimed inventions is that pixels are processed in a particular order, such as raster order, using only the memory required by a band buffer. By using only the band buffer, memory requirements are significantly reduced in comparison with the amount of memory required by known methods for creating a blur effect. Another advantage is that a blur effect is created with a minimal amount of processing, allowing the effect to be created faster and using less power than required with known methods.

The variable motion blur unit 82 may be comprised of a plurality of discrete logic gates and devices selected and designed to perform the functions described as well as other functions. Alternatively, the variable motion blur unit 82 may be comprised of logic gates and devices produced by a hardware definition language, such as Verilog™ or VHDL. In another alternative, the variable motion blur unit 82 may be comprised of a suitable processor and a memory to execute a program of instructions stored in the memory together with image data for one segment of original image pixels, wherein the program of instructions when executed by the processor performs a method to create modified pixels from original image pixels according to the method described above. In addition, the parameter register 94 may comprise one or more than one storage devices. The register 94 may a discrete device such as a flip-flop or a plurality of flip-flops integrated on the IC of the display controller, or it may comprise one or more storage locations in a memory, such as the memory 74.

The claimed inventions may be embodied as machine readable medium embodying a program of instructions for execution by the machine to perform a method for creating a blur effect. The machine or computer readable medium may be any data storage device that can store data which can be thereafter read by a computer system. Examples of the computer readable medium include flash memory, hard drives, network attached storage, ROM, RAM, CDs, magnetic tapes, and other optical and non-optical data storage devices. The computer readable medium can also be distributed over a network-coupled computer system so that the computer readable code is stored and executed in a distributed fashion.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. An apparatus for creating a blur effect in a portion of an original image comprised of pixels arranged in a first order, wherein the portion is divided into at least two bands, the apparatus comprising:
a buffer to store a plurality of original image pixels;
a pixel modification unit to determine a replacement pixel for a corresponding original image pixel of a particular segment by calculating an average of the corresponding original image pixel and at least one other original image pixel of the particular segment, a segment being a plurality of sequential pixels in one of the at least two bands; and
a selection unit to select the corresponding original image pixel and the at least one other pixel, wherein the number of other pixels selected varies with the band in which the segment is located.

2. The apparatus of claim 1, wherein the at least one other pixel follows the corresponding original image pixel in the first order.

3. The apparatus of claim 1, wherein the first order is a raster order.

4. The apparatus of claim 3, wherein the at least two bands divide the original image horizontally and the number of other pixels selected for inclusion in the average increases with the band moving from left to right in the original image.

5. The apparatus of claim 3, wherein the at least two bands divide the original image horizontally and the number of other pixels selected for inclusion in the average decreases with the band moving from left to right in the original image.

6. The apparatus of claim 1, wherein the at least two bands divide the original image vertically, and the first order proceeds in columns from the top row to the bottom row of the original image.

7. The apparatus of claim 1, wherein the buffer is a shift register.

8. The apparatus of claim 7, wherein the selection unit selects the corresponding original image pixel and the at least one other pixel by causing pixels stored in the buffer to be shifted.

9. The apparatus of claim 1, wherein the buffer stores at least a segment.

10. A method for creating a blur effect in a portion of an original image comprised of pixels arranged in a first order, the method comprising:
dividing the portion of the original image into at least two bands;
creating a first modified pixel to replace a corresponding first original image pixel by computing the average of the first original image pixel and one other original image pixel, wherein the first and the one other original image pixels are included in a first segment of the original image, the first segment being a plurality of sequential pixels in a first band; and
creating a second modified pixel to replace a corresponding second original image pixel by computing the average of the second original image pixel and at least two other original image pixels, wherein the second original image pixel and the at least two other original image pixels are included in a second segment of the original image, the second segment being a plurality of sequential pixels in a second band.

11. The method of claim 10, wherein the one other original image pixel immediately follows the first original image pixel in the first order, and the at least two other original image pixels immediately follow the second original image pixel in the first order.

12. The method of claim 10, wherein first and second segments are respective portions of the same row of the original image.

13. The method of claim 12, wherein the first order is a raster order.

14. The method of claim 10, wherein first and second segments are respective portions of the same column of the original image.

15. The method of claim 14, wherein the first order proceeds in columns from the top row to the bottom row of the original image.

16. The method of claim 10, wherein the at least two bands are equally sized.

17. The method of claim 10, wherein the portion of the original image includes the full original image.

18. A medium readable by a machine embodying a program of instructions for execution by the machine to perform a method for creating a blur effect in a portion of an original image comprised of pixels arranged in a first order, the method comprising:
dividing the portion of the original image into at least two bands;
causing a first plurality of pixels of a first segment of the original image to be stored in a buffer, the first segment being all of a plurality of a consecutive sequence of pixels mutually extending in the same direction in a first band;
replacing a first original image pixel of the first segment with an average of the first original image pixel and one other original image pixel of the first segment;
causing a second plurality of pixels of a second segment of the original image to be stored in the buffer, the second segment being all of a plurality of a consecutive sequence of pixels mutually extending in the same direction in a second band; and
replacing a second original image pixel of the second segment with an average of the second original image pixel and at least two other original image pixels of the second segment.

19. The method of claim 18, wherein the one other original image pixel immediately follows the first original image pixel in the first order, and the at least two other original image pixels immediately follow the second original image pixel in the first order

20. The method of claim 19, wherein the first order is a raster order.
